(19) United States
(12) Patent Application Publication
(10) Pub. No.: US 2013/0295543 A1
(43) Pub. Date: Nov. 7, 2013

(54) Folding tesseract

(71) Applicant: Gary Neal Poovey, Escalon, CA (US)

(72) Inventor: Gary Neal Poovey, Escalon, CA (US)

(21) Appl. No.: 13/506,595

(22) Filed: May 2, 2012

(51) Int. Cl. G09B 23/06

(52) U.S. Cl. 434/300

(57) ABSTRACT

This invention teaches a way to illustrate a tesseract and four dimensional properties of the laws of physics. A method is disclosed that teaches how to make tesseract models that can be made out of materials that fold. These tesseract models can be installed in books with a tether between pages to erect the tesseract in a three dimensional form when the pages of the book are spread for reading.

### BACKGROUND OF THE INVENTION

1. Field of the Invention

This invention relates to a way to make a tesseract model that can fold up and then it can be unfolded again.

2. Description of the Prior Art

U.S. Pat. No. 6,491,563 which teaches BALL AND SOCKET CONSTRUCTION TOY published by Scott Bailey on Dec. 10, 2002 gives a way of constructing tesseracts. These illustrative tesseracts cannot be folded to be used in book illustrations. Methods for constructing folding three dimensional objects are disclosed in U.S. Pat. No. 6,497,601 published by Eric Ward on Dec. 24, 2002 which teaches FOLDING THREE DIMENSIONAL CONSTRUCTION. Mr. Ward does not include a tesseract in the collection of objects that U.S. Pat. No. 6,497,601 features.

U.S. Pat. No. 5,982,374 which teaches VALLIAN/GEOMETRIC HEXAGON OPTING SYMBOLIC TESSERACT V/GHOST published by Larry Wahl in Nov. 9, 1999 displays tessearcts on a computer that are inaccessible to small children or those who are computer illiterate.

### SUMMARY OF THE INVENTION

Paper, plastic, cardboard, or a composite material can be fashioned into a FOLDING TESSERACT. In these tesseracts the hinges are a crease in the material. These FOLDING TESSERACTs can be installed in a book with a tether that pulls the tesseract up to be looked at when the pages of the book are opened. Sturdier version of the FOLDING TESSERACT can be fashioned out of flat wooden or metal parts with the hinges being fashioned out of rubber, leather, or a hinge fastened to the members of the tesseract model. One simple from of the tesseract that is a cube connected to a second cube at each corner by a member that is attached at an angle other than a 90 degree angle will be used here. A cube in this simplified usage is an assembly of 12 members connected at eight corners in sets of three members. Each of the three members connected at a corner are 90 degrees away from each other.

By fashioning the cubes of the tesseract and the connecting members of the tesseract with hinges that all align with one of the dimensions of the cube, a folding tesseract may be constructed. Tesseracts of this kind can be colored so that four dimensional characteristics of space-time can be illustrated for children to understand. Four dimensional characteristics of momentum and energy can be illustrated for those who are computer illiterate. By using these tesseracts in books with FOLDING TESSERACT'S that pop up when the book is opened, knowledge about four dimensional reality is available to all.

An alternative tesseract that can be used for this use of four dimensional illustrations is two diamond like cubic structures that have an acute angle between two of the members and an oblique angle between two others. This kind of tesseract based on diamond like cubic structures is another example of the four dimensional tesseract that can be illustrated in a three dimensional model.

### BRIEF DESCRIPTION OF THE DRAWINGS

FIG. 1 is a view of a cube that has hinges at the corners that are all aligned in one direction.

FIG. 2 is a view of two interlocked cubes with all of the members hinged so that it can be folded together.

FIG. 3 is a view of a FOLDING TESSERACT composed of two connected cubes.

FIG. 4 is a view of a FOLDING TESSERACT composed of diamond cross section cubic forms.

### BEST MODE FOR CARRYING OUT THE INVENTION

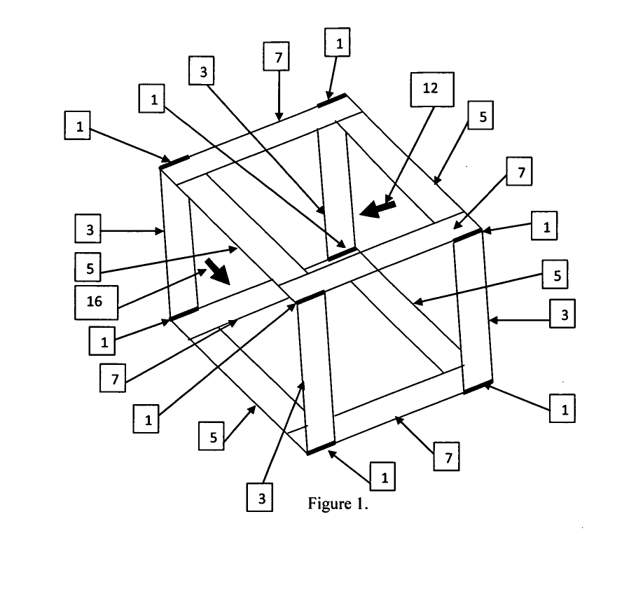

This description of the invention will be referring to the drawings provided. In FIG. 1, a cube is seen. The cube is composed of eight hinges numbered 1. The cube is composed of four vertical members numbered 3. The cube is composed of four front to back members numbered 5, and finally, the cube is composed of four right to left members numbered 7. All the members are composed of flat material whether it is paper or a wood plank. Members numbered 3, 5, and 7 represent the three dimensions of space. When the cube is erected to stand up all the members are separated by 90 degree angles.

In folding, the angle between members numbered 3 and 5 changes from 90 degrees to allow the cube to collapse to a flat assembly. In the completely folded cube, members 3 and 5 lay against each other in a line. The angle between members numbered 3 and 5 become zero degrees at one joint and 180 degrees at the next joint. Member 7 remains separated from 3 and 5 by 90 degrees when 3 and 5 are collinear. Two of the members numbered 7 come to lie next to each other while the other two are separated to the opposite ends of the flat assembly. A dark arrow 12 is provided to indicate a direction that the folding can take. Alternatively the cube can be folded in the direction indicated by dark arrow 16. When the assembly is unfolded from the flat folded condition all the angles between the members numbered 3 and 5 are restored to 90 degrees.

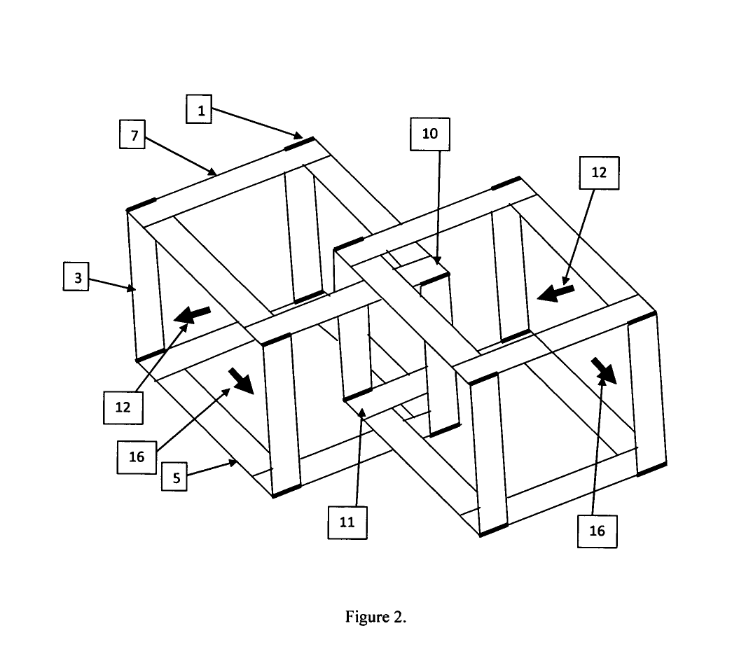

FIG. 2 is of two interlocked cubes. The numbering of the parts is identical to the numbering of the single cube in FIG. 1, but two corners are numbered in FIG. 2. The corner numbered 10 is the corner of the cube that is the most to the left on the page that is inside the second cube. The corner numbered 11 is the corner of the second cube that is inside the cube that is the most to the left on the page. It will be noticed that the two cubes have their hinges 1 oriented so that the two cubes can be folded to flat as the one cube in FIG. 1 can be folded. In this folding, as before described for the cube in FIG. 1, the angles between the members numbered 3 and 5 change from 90 degree angles to allow the folding. The two cubes become flat together. Dark arrow 12 is provided to indicate a direction of the folding action. Alternatively the folding action can be in the direction of Dark arrow 16.

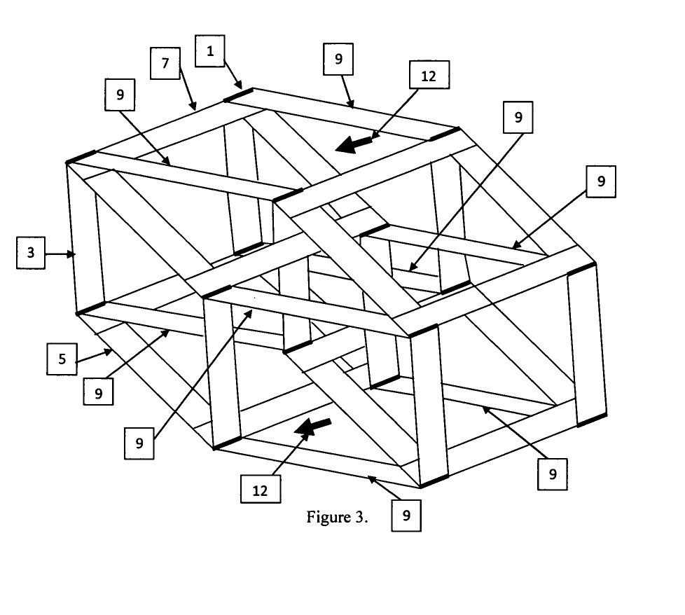

In FIG. 3, it will be noticed that the two cubes of FIG. 2 are present but joined by members numbered 9 at each of the eight corresponding corners of each of the two cubes. FIG. 3 is a tesseract and the members numbered 9 are the illustration of the fourth dimension. Alternatively any one of the four members can be chosen to be the fourth dimension with the other three being the three we are familiar with. This tesseract can be used to illustrate three dimensions in space and one dimension in time. This tesseract can be used to illustrate the three component vectors of the momentum of a body in motion while the fourth illustrates the energy. Dark arrow 12 is again provided to indicate the preferred direction of the folding to a flat condition. The folded tesseract can be installed in a book with a tether that pulls up the tesseract into its full height above the book as the page is pulled opened. Alternatively the folding tesseract can be connected to the pages so that as the pages are opened the tesseract is erected.

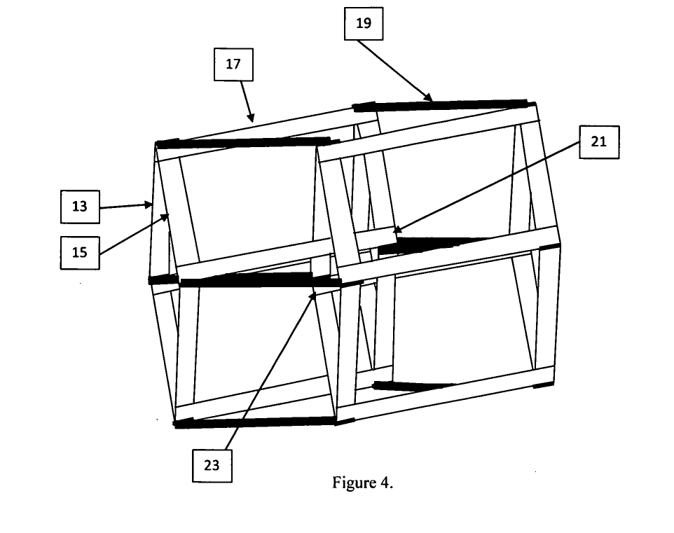

FIG. 4 illustrates a tesseract fashioned from diamond shaped components instead of the cubic components of FIGS. 1, 2, and 3. There are eight members that are oriented as the member numbered 13 is oriented. There are eight members that are oriented as the member numbered 15 is oriented. There are eight members oriented as the member numbered 17 is oriented. There are eight members oriented as the member numbered 19 is oriented. Discerning the location of all of the members numbered 19 is difficult, but with study they can be found. In FIG. 4, corner 21 is a corner of the left most diamond form. Corner 21 is interlocked in the second diamond form. Corner 23 has been labeled which is the corner of the second diamond form that is interlocked in the diamond form that is the left most in FIG. 4.

Many other tesseracts than the ones in the drawings provided can be fashioned using these same principles. Tesseracts composed with curving members can be constructed to illustrate Einstein's general relativity with curved space and time relationships. Other angles between the four component members can be used to construct tesseracts. The first folding tesseracts built by this inventor were of folded paper with connections made with adhesive tape. Many variations of tesseracts can be fashioned using the methods disclosed here using different lengths of the component members, using different shapes of the component members, using different angles between the members, and colors can also be employed for illustration.

What I claim as my invention is:

1. A method for fashioning folding tesseracts of flat members that are attached to each other by hinges.

2. A method for fashioning folding tesseracts as is claimed in claim 1 where the hinges are creases in the composing material.

3. A folding tesseract as is claimed in claim 1 where the members are composed of paper.

4. A folding tesseract as is claimed in claim 1 where the members are composed of card board.

5. A method for fashioning folding tesseracts as is claimed in claim 1 where the flat members are curved in shape.

6. A method for fashioning folding tesseracts as is claimed in claim 1 that can be installed in books where the tesseract is erected by opening the pages of the book.

7. A folding tesseract that folds flat and can be erected to a three dimensional form from the folded flat condition composed of flat members connected together by hinges.

8. A folding tesseract as is claimed in claim 7 that is composed of two cubic forms connected by eight members at each corresponding corner.

9. A folding tesseract as is claimed in claim 7 that is composed of diamond shaped forms connected at each corner by eight members to each corresponding corner.

10. A folding tesseract as is claimed in claim 7 that is composed of three dimensional forms connected at the corners by members at each corresponding corner.

11. A folding tesseract as is claimed in claim 7 that can be incorporated in a book where the tesseract is erected by opening the pages of the book.

12. A folding tesseract as is claimed in claim 7 where the composing members are different shapes.

13. A folding tesseract as is claimed in claim 7 where the hinges are a crease in the material of the composing members.
